(19) United States
(12) Patent Application Publication
(10) Pub. No.: US 2009/0047450 A1
(43) Pub. Date: Feb. 19, 2009

(54) Image Receiving Layer Suitable For Thermography For Portable Data Carriers, and Portable Data Carrier

(76) Inventors: Josef Riedl, Attenkirchen (DE); Daniel Ganz, Sattel (CH); Willy Frei, Luzern (CH); Christian Schanzer, Jona (CH)

Correspondence Address: BACON & THOMAS, PLLC, 625 SLATERS LANE, FOURTH FLOOR, ALEXANDRIA, VA, 22314-1176, US

(21) Appl. No.: 11/922,199

(22) PCT Filed: Jun. 16, 2006
(86) PCT No.: PCT/EP2006/005798

§ 371 Date: Apr. 30, 2008

(30) Foreign Application Priority Data
Jun. 17, 2005 (DE) 10 2005 028 161.3

(51) Int. Cl. B41M 5/40; B29C 47/06

(52) U.S. Cl. 428/32.39; 264/173.16; 156/244.11

(57) ABSTRACT

An image-receiving layer (1) for receiving information (5) transferred by transfer thermography, and the use of same in portable data carriers. According to the invention, the image-receiving layer (1) is formed of two parts, a carrier layer (2) as well as an acceptor layer (3), and is produced by co-extruding two source materials, one of which being an amorphous polyester, e.g. PETG, the other a mixture of PETG with 10 to 90 wt. % styrene polymer.

It is the object of the invention to apply graphic information on a portable data carrier using a thermographic method. In particular the invention concerns the thermo-personalization of identification cards such as bank cards, driving licenses or identification cards.

A portable data carrier with an image-receiving layer which can be printed using a thermal transfer method is known from US 2005/0035590. The data carrier described therein has the form of an identification document and is based on a core layer, which can consist i. a. of polycarbonate or polyethylene terephthalate (PET), on which a laminating layer is applied, consisting of a transparent material, such as for example polycarbonate, polypropylene, ABS copolyester or thermal plastic. On the laminating layer an image-receiving layer is applied, which is in particular suitable for printing by thermal sublimation, also known as D2T2 (“die diffusion thermal transfer”). The image-receiving layer consists of polyvinyl chloride (PVC); in addition a multitude of possible alternative materials is mentioned, i. a. polystyrene and its copolymers. The proposed card allows for reliable printing by thermal sublimation. However, the PVC used for the image-receiving layer is problematic in view of its environmental safety and its recyclability. PVC-coated cards furthermore have a relatively low durability, adversely affecting their suitability for long-lived applications, such as for example identification cards.

From EP 0 734 322 B1 a multilayer data carrier is known, consisting of an opaque core layer, both sides of which are covered by a cover layer of modified polyester (PETG). Data are incorporated in the PETG layer by means of a laser. Additives can be added to the PETG layers in particular for the improvement of their suitability for laser printing. The layers are connected by laminating. In order to prevent the cover layers' adhesion to the laminating tool, antiblocking agents are added to the outer surfaces of the cover layers. Therein the cover layers are produced as a two-part laminate by co-extrusion of a PETG layer with added anti-blocking agent and a layer of pure PETG. From the Patent Abstracts of Japan JP 2004042358 A an image-receiving layer is known which is suitable for receiving printed patterns applied by thermal sublimation. The proposed image-receiving layer consists of a core layer, on which a heat insulation layer of polystyrene is applied, on which in turn an acceptor layer is disposed, containing a dyeable resin. The image-receiving layer is intended for use in particular in IC cards.

From WO 02/41245 A2 furthermore a multifunctional card body is known, which is formed by laminating several layers, wherein at least one of the layers was produced by co-extrusion of at least two types of plastic. As source material for the co-extruded layer i. a. PETG is proposed.

From JP 2004025743 A furthermore a plastic card suitable for printing by means of transfer thermography is known, doing justice to a growing demand for non-PVC cards. A card is proposed with a core layer based on ABS, PETG or polycarbonate and a superposed layer based on the same materials, however containing a share of at least 20 wt. % ABS. Such ABS-containing image-receiving layers have turned out to be unsatisfactory in our own tests when used in combination with thermal sublimation methods.

In order to avoid forming material elevations during punching and in order to improve the temperature stability, from JP 11189708 A a proposal for improving the hardness of card material is known, which takes account of the circumstance that PVC-containing cards will be accepted less in the future for reasons of environmental protection. It is proposed to use a material mixture of PETG and polycarbonate, wherein a share of 10% up to 70% of the PETG is modified by other materials. As modification material i. a. AAS (methacrylate-acrylic-styrene) is mentioned. The proposed material has good mechanic properties, but it is not readily suitable for multilayer, laminated card body structures.

The invention is based on the problem of providing an image-receiving layer on a polyester basis suitable for application on portable data carriers, on which layer graphic information can be applied through transfer thermography, in particular through thermal sublimation.

This object is solved by an image-receiving layer with the features of claim 1, as well as a portable data carrier equipped therewith the features of claim 6. The object is furthermore solved by a method for producing an image-receiving layer in accordance with independent claim 11, as well as a method for producing a portable data carrier in accordance with independent claim 12.

The inventive image-receiving layer is characterized by the fact that it can be provided reliably and pixel by pixel with graphic information using a transfer thermography method, wherein it is equally suitable for the thermal transfer and the thermal sublimation method. For carrying out the transfer thermography conventional installations can be used, special adaptations for application for portable data carriers are not necessary. The inventive image-receiving layer has the advantage that when the thermal transfer method is used the color carrier tape does not stick to it. Therefore, no adhesive effects are produced, which lead to undesirable color transfers from the color carrier tape onto the image-receiving layer. Thus a pixel-by-pixel color transfer, e.g. by means of needles, can take place also in the thermal transfer method. Upon the use of both the thermal sublimation and the thermal transfer a clear, controlled color transfer takes place. It is a further advantage of the inventive image-receiving layer that also a cover layer applied on top of the graphic information, for the protection of the same, adheres to it well. Through its structure of a multilayer laminate consisting of a carrier layer and an acceptor layer, the inventive image-receiving layer can be laminated on core layers which are common in the production of data carriers. The laminating properties of the image-receiving layer are determined by the carrier layer and not by the characteristics of the acceptor layer. Since the image-receiving layer is based substantially on PETG, it furthermore has a good long-term stability, can be recycled well and consequently is environmentally friendly.

The inventive image-receiving layer can be produced in a particularly advantageous manner by co-extruding a first source material in the form of pure PETG and a second source material in the form of a mixture of PETG with at least 10 wt. % polystyrene. The sheet produced by co-extrusion can be further processed without any special additional measures and thereby facilitates the implementation of the inventive method.

Expediently, the polystyrene contained in the acceptor layer is a styrene polymer from the group of the styrene copolymers. Particularly preferably it is an acrylonitrite styrene acrylic ester (ASA). Its use is supported by the implementation of the image-receiving layer as a laminate, in which the acceptor layer can be kept proportionally thin. Thereby primarily the undesirable influence of the color characteristics of ASA—it has a slightly yellowish inherent color—can be minimized.

An embodiment of the invention will hereinafter be explained in more detail with reference to the drawing.

The FIGURE shows a cross section of an image-receiving layer applied on a portable data carrier.

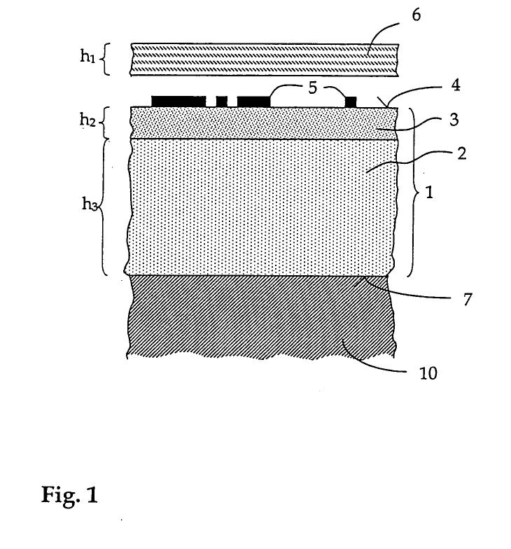

FIG. 1 shows a two-part image-receiving layer 1 with a carrier layer 2 and an acceptor layer 3. On the surface 4 of the acceptor layer 3 graphic information 5 in the form of alphanumeric characters and/or image elements of any shape is applied. On top of the surface 4 with the graphic information 5 a cover layer 6 is disposed, which is represented separately from the surface 4 in the FIGURE for clarity's sake. On the bottom side 7 the image-receiving layer 1 is connected to a core layer 10 of a not further shown portable data carrier. The image-receiving layer 1, the cover layer 6 and the core layer 10 are provided separately, to be connected using suitable connection techniques. Typically the layers 1 and 10 are first present as sheets, which are cut to match the geometry of the portable data carrier and are then put together. The cover layer 6 can also be present as a thin film, or is applied in the form of a lacquer.

The portable data carrier, on the core layer 10 of which the image-receiving layer 1 is applied, typically is a conventional check card, cash card, bank card, identification card, driving license card, data sheet for a passport book, SIM card or a comparable chip card, smart card or IC card in the check card format or another usual card format, on which an identity information or another figurative or textual information allocated to an issuer or a user is disposed. Portable data carrier is to be understood to encompass also other personalized items with at least one planar surface and a comparable function, such as for example bracelets. In the following an embodiment in the form of an identification card in the credit card format is used as embodiment of the portable data carrier. Identification cards of this type and their production are sufficiently known, for example from the “Handbuch der Chipkarten” (Handbook of Chip Cards) W. Rankl, W. Effing, Hansa-Verlag, Munich, 4th edition. They contain in particular a core layer 10, which can be designed to consist of one layer, but is preferably a laminate of several partial layers. The core layer 10 is preferably based on polycarbonate or on polyester and has a thickness of typically 600 μm.

The graphic information 5 is formed by colored pixels, which are transferred from a color carrier tape onto the surface 4 by a method of transfer thermography. A conventional thermal transfer method or a conventional thermal sublimation method is used, such as described for example in the “Handbuch der Printmedien” (Handbook of Printing Media) H. Kipphahn, Springer Verlag Heidelberg, 2000, chapter 5.6. The graphic information can in particular contain a color photograph.

The base material of the carrier layer 2 is preferably an amorphous polyester. One possible material is in particular PETG, i.e. a modified polyethylene terephthalate, as described for example in EP 0 734 322 B1, which was mentioned above. Alternatively the carrier layer 2 can consist of pure polyester or other polyester modifications. In a further variant the carrier layer 2 can also consist of polycarbonate. The carrier layer 2 has a height h₃ of typically 100 μm.

The source material of the acceptor layer 3 is also PETG, however to which, in contrast to the carrier layer 2, a styrene polymer amounting to a share of at least 10 wt. % is added. A styrene polymer from the group of acrylonitrite styrene acrylic esters (ASA) is particularly suitable. The styrene polymer share in the acceptor layer 3 can amount to up to 90%. The exact mixing ratio depends on the actual chemical properties of the used styrene polymer, if ASA is used for example on the ratio of the individual components contained in ASA. Furthermore, the exact mixing ratio depends on the transfer thermography technique—thermal transfer or thermal sublimation—used to transfer the graphic information 5, and on the color material used for producing the pixels. A share of 70 wt. % styrene polymer in the acceptor layer 3 has proven to be an expedient approximate value in the case that thermal sublimation is used. The acceptor layer 3 is thinner than the carrier layer 2 and has a height h₂ of typically 10 μm.

A lubricant or antiblocking agent can be added in particular to the acceptor layer 3, but also to the carrier layer 2, in order to improve workability during the production of the sheets and of the cards, here especially to avoid an adhesion of the acceptor layer 3.

The cover layer 6 primarily serves to protect the graphic information 5. It is transparent and has a small height h₁ of typically 3 to 25 μm. The cover layer 6 is applied after applying the graphic information 5 by the simultaneous application of heat and pressure. Expediently, the cover layer 6 is applied directly after the application of the graphic information 5, e.g. in a conventional “hot stamping” process at a temperature of 100 to 190°. As base material of the cover layer 6 a lacquer comes into question, such as the lacquer available from the company DATACARD under the name “Topcoat”. It is also possible to use e.g. a 25 μm thin PET film.

The image-receiving layer 1 is provided as a laminate in the form of one single sheet. This sheet is produced by co-extruding molten polymer mass of the source materials for the carrier layer 2 and for the acceptor layer 3 in an installation with at least 2 extruders. The molten polymer masses from the extruder for the carrier layer 2 and the extruder for the acceptor layer 3 are combined in one single nozzle; alternatively, they are output by two nozzles and rolled together directly afterward. The principles of the respectively underlying sheet production are known and are described for example in the book “Kunststoff-Folien” (Plastic sheets), J. Mendwick, Carl Hanser Verlag Munich, 1994, particularly chapters 3.2.2. and 3.2.8. The principle of output by two nozzles with subsequent rolling is furthermore also explained in EP 0 734 322, which was mentioned above.

With the proposed image-receiving layer 1 an identification card can be produced as follows. A core layer 10 is provided, which was typically produced by laminating several individual layers. Furthermore, the image-receiving layer 1 is produced and provided by co-extruding the carrier layer 2 and the acceptor layer 3. Subsequently, the image-receiving layer 1 and the core layer 10 are connected to each other through a further laminating step, wherein the connection is established in such a way that the carrier layer 2 lies between the acceptor layer 3 and the core layer 10. The laminating steps are carried out observing laminating parameters which are usual for the production of identification cards. Subsequently, the graphic information 5 is applied on the thus prepared identification-card body through transfer thermography. Afterward, the cover layer 6 is applied on the surface 4 with the graphic information 5 in a “hot stamping” step.

While retaining the basic thought of using a two-part image-receiving layer 1 on the basis of PETG, produced by co-extrusion, wherein the acceptor layer consists of a mixture of PETG with a styrene polymer, the invention allows a multitude of appropriate embodiments. Thus image-receiving layers 1 can of course be arranged on two sides of a core layer 10 and can both be provided with graphic information 5. The carrier layer 2 and the acceptor layer 3 can furthermore also be formed of several layers, wherein the several layers are co-extruded analogously to the two-part structure. Moreover, additives for achieving certain desirable material properties, such as greater hardness or greater elasticity, can be added to individual layers.

1. Image-receiving layer for receiving graphic information transferable by transfer thermography, the layer comprising a laminate including a carrier layer and an acceptor layer, wherein the carrier layer substantially consists of an amorphous polyester, and the acceptor layer substantially consists of a mixture of PETG with at least 10 wt. % polystyrene.

2. Image-receiving layer according to claim 1, wherein the laminate comprises a single sheet produced by co-extrusion.

3. Image-receiving layer according to claim 1, wherein the polystyrene contained in the acceptor layer is a styrene polymer from the group styrene copolymers.

4. Image-receiving layer according to claim 1, wherein the layer has an overall height of 80 to 120 μm, of which a height of 5 to 20 μm is allotted to the acceptor layer.

5. Image-receiving layer according to claim 1, wherein the acceptor layer includes a lubricant and/or antiblocking agent.

6. Image-receiving layer according to claim 1, wherein the carrier layer comprises polycarbonate.

7. Portable data carrier of a multilayer design, comprising a core layer and an image-receiving layer on which graphic information is applied by transfer thermography, wherein the image-receiving layer comprises a carrier layer of PETG as well as an acceptor layer comprising a mixture of PETG with 10 wt. % styrene copolymer.

8. Portable data carrier according to claim 7, wherein the image-receiving layer is arranged on a core layer of polyester.

9. Portable data carrier according to claim 7, including a transparent cover layer on the surface of the acceptor layer.

10. Method for producing an image-receiving layer for receiving graphic information applied by transfer thermography, comprising co-extruding a first polymer melt of PETG as well as a second polymer melt of a mixture of PETG and at least 10 wt. % styrene copolymer to form a laminate.

11. Method for producing a portable data carrier, for example an identification card, on which graphic information can be applied by transfer thermography, comprising the steps:
providing a core layer on a polyester basis or polycarbonate basis,
providing a first source material substantially containing PETG,
providing a second source material containing a mixture of PETG and at least 10 wt. % polystyrene,
co-extruding the two source materials to form an image-receiving layer,
laminating the image-receiving layer and the core layer, so that the carrier layer lies between the acceptor layer and the core layer.

12. Image-receiving layer according to claim 3, wherein the styrene copolymer comprises acrylonitrile styrene acrylic ester.
